(19) United States
(12) Patent Application Publication
(10) Pub. No.: US 2014/0321587 A1
(43) Pub. Date: Oct. 30, 2014

(54) Magnetically Contained Energized Plasma

(71) Applicant: UNIVERSITY OF WASHINGTON THROUGH ITS CENTER FOR COMMERCIALIZATION, Seattle, WA (US)

(72) Inventor: Thomas R. Jarboe, Bellevue, WA (US)

(73) Assignee: UNIVERSITY OF WASHINGTON THROUGH ITS CENTER FOR COMMERCIALIZATION, Seattle, WA (US)

(21) Appl. No.: 14/354,209

(22) PCT Filed: Nov. 14, 2012
(86) PCT No.: PCT/US12/65031

§ 371 Date: Apr. 25, 2014

Related U.S. Application Data
(60) Provisional application No. 61/559,323, filed on Nov. 14, 2011.
(60) Provisional application No. 61/669,417, filed on Jul. 9, 2012.

(51) Int. Cl. G21B 1/05

(52) U.S. Cl. CPC G21B 1/05
USPC 376/133

(57) ABSTRACT

A method of inductively energizing a plasma in a confinement chamber (110) is disclosed. A gas is introduced to the confinement chamber (110) and energized to form a plasma having a toroidal current defined by rotation of the plasma within the confinement chamber (110). Magnetic flux is injected into the confinement chamber (110) by applying current through conductive coils (126) of a helicity injector (120) with ends fluidly connected to the confinement chamber (110). Voltage (122) is applied across the ends of the helicity injector (120) to create edge currents around an outer surface of the plasma in the confinement chamber (110) and asymmetric magnetic perturbations across the plasma sufficient to couple adjacent zonal flows. Magnetic flux (126) is injected and voltage (122) is applied across the helicity injector periodically and in phase at a frequency that exceeds 5.8 kilohertz. Gas is removed from the confinement chamber (110) to achieve a plasma density sufficient for separatrix formation.

### CROSS-REFERENCE TO RELATED APPLICATIONS

This application claims the benefit of U.S. Provisional Patent Application No. 61/559,323, filed Nov. 14, 2011; and U.S. Provisional Patent Application No. 61/669,417, filed Jul. 9, 2012, the contents of each of which are incorporated herein by reference in their entirety.

### STATEMENT REGARDING FEDERALLY SPONSORED RESEARCH OR DEVELOPMENT

This invention was made with government support under DE-FG02-96ER54361 awarded by the Department of Energy. The government has certain rights in the invention.

### BACKGROUND

Unless otherwise indicated herein, the materials described in this section are not prior art to the claims in this application and are not admitted to be prior art by inclusion in this section.

Fusion is the process of combining two nuclei together. When two nuclei of elements with atomic numbers less than iron are fused energy is released. The release of energy is due to a slight difference in mass between the reactants and the products of the reaction and is governed by ΔE=Δmc².

The fusion reaction requiring the lowest plasma temperature occurs between deuterium, a hydrogen atom with an extra nucleus, and tritium, a hydrogen atom with two extra nuclei. This reaction creates a helium atom and a neutron.

One approach for achieving thermonuclear fusion is to energize a gas containing fusion reactants inside a reactor chamber. The energized gas becomes a plasma upon becoming ionized. To achieve conditions with high enough temperatures and densities for fusion the plasma needs to be confined. Magnetic confinement keeps plasmas away from chamber walls because charged particles in the plasma (e.g., electrons and ions) tend to follow magnetic field lines. There are several devices exploring the possibility of magnetic confinement for thermonuclear fusion, including: spheromaks, tokamaks, stellarators, reversed-field pinches (RFP), field-reversed configurations (FRC) and z-pinches.

While the geometries of the device configurations vary, generally a torus-shaped reactor chamber is used to enclose the plasma. The plasma can be both energized and urged to circulate around the torus-shaped chamber to create a toroidal current by a number of techniques. For example, incident radio frequency radiation and/or neutral beams can be used to selectively transfer momentum to particles in the plasma. A toroidal magnetic field, such as generated by conductive coils wrapped poloidally around the torus-shaped chamber, steers the plasma circulating in the torus-shaped chamber and prevents interference with the chamber walls. Coils may also be wrapped around such a torus-shaped confinement chamber in a toroidal direction to generate fields in a poloidal direction. Additionally, the current of the circulating plasma and/or additional electromagnetic coils may create a magnetic field in the poloidal direction of the torus-shaped chamber.

Plasma in such a chamber is therefore guided according to the combination of externally generated fields and any self-generated magnetic fields, if present.

### SUMMARY

Some embodiments of the present disclosure provide a method of inductively energizing a plasma in a confinement chamber. The method can include inserting into the confinement chamber a gas comprising atomic hydrogen, deuterium, tritium, helium, or combinations thereof. The method can include energizing the gas to form a plasma having a toroidal current defined by rotation of the plasma within the confinement chamber. The method can include injecting magnetic flux into the confinement chamber by applying current through conductive coils of at least one helicity injector, wherein the at least one helicity injector comprises a tubular enclosure with two ends both fluidly connected with the confinement chamber. The method can include applying voltage across the two ends of the at least one helicity injector to create: (i) edge currents around an outer surface of the plasma in the confinement chamber, and (ii) asymmetric magnetic perturbations across the plasma sufficient to couple adjacent zonal flows circulating within the confinement chamber along a direction of the toroidal current. The method can include removing gas from the confinement chamber to achieve a plasma density sufficient for separatrix formation. The injecting magnetic flux and the applying voltage via the at least one helicity injector are carried out periodically and in phase with respect to one another at a frequency that exceeds 5.8 kilohertz.

Some embodiments of the present disclosure provide a plasma confinement system including a confinement chamber, at least one helicity injector, and a controller. The confinement chamber can be for confining a gas comprising atomic hydrogen, deuterium, tritium, helium, or combinations thereof that is energized to form a plasma. The at least one helicity injector can include a tubular enclosure with two ends both fluidly connected with the confinement chamber via first and second ports. The at least one helicity injector can include conductive coils arranged such that current in the conductive coils results in magnetic flux injected into the confinement chamber. The at least one helicity injector can include electrical terminals arranged to apply voltage across the two ends of the at least one helicity injector to thereby create: (i) edge currents around an outer surface of the plasma in the confinement chamber, and (ii) asymmetric magnetic perturbations across the plasma sufficient to couple adjacent zonal flows circulating within the confinement chamber. The controller can be configured to operate the conductive coils and electrical terminals of the at least one helicity injector so as to inductively energize plasma in the confinement chamber by injecting magnetic flux and applying voltage via the at least one helicity injector periodically and in phase with respect to one another at a frequency that exceeds 5.8 kilohertz.

Some embodiments of the present disclosure provide a computer readable medium storing instructions that, when executed by one or more processors in a computing device, cause the computing device to perform operations. The operations can include inserting into a confinement chamber a gas comprising atomic hydrogen, deuterium, tritium, helium, or combinations thereof. The operations can include energizing the gas to form a plasma having a toroidal current defined by rotation of the plasma within the confinement chamber. The operations can include injecting magnetic flux into the confinement chamber by applying current through conductive coils of at least one helicity injector, wherein the at least one helicity injector comprises a tubular enclosure with two ends both fluidly connected with the confinement chamber. The operations can include applying voltage across the two ends of the at least one helicity injector to create: (i) edge currents around an outer surface of the plasma in the confinement chamber, and (ii) asymmetric magnetic perturbations across the plasma sufficient to couple adjacent zonal flows circulating within the confinement chamber along a direction of the toroidal current. The operations can include removing gas from the confinement chamber to achieve a plasma density sufficient for separatrix formation. The injecting magnetic flux and the applying voltage via the at least one helicity injector can be carried out periodically and in phase with respect to one another at a frequency that exceeds 5.8 kilohertz.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a functional block diagram of a plasma confinement system.

FIG. 2A is a cross-section view of an example plasma confinement system configured to be energized inductively by axially offset helicity injectors.

FIG. 2B is a disassembled view of one of the helicity injectors shown in FIG. 2A.

FIG. 3 is an aspect view of the assembled plasma confinement system shown in FIG. 2 with schematic voltage injection and magnetic flux injection circuits shown for one helicity injector.

FIG. 4A is an example plot of injector voltage versus time for the example plasma confinement system shown in FIG. 3.

FIG. 4B is an example plot of injector magnetic flux versus time for the example plasma confinement system shown in FIG. 3.

FIG. 4C is an example plot of injector plasma current versus time for the example plasma confinement system shown in FIG. 3.

FIGS. 5A-5D are illustrative diagrams of magnetic field lines in the confinement chamber and in one helicity injector at times t_{A}-t_{D} as shown in FIGS. 4A-4C.

FIG. 6 provides indicators of plasma toroidal current in the confinement chamber and plasma injector currents in the helicity injectors of the example plasma confinement system.

FIG. 7 is a flowchart of a process for operating a plasma confinement system according to an example embodiment.

FIG. 8 depicts a computer-readable medium configured according to an example embodiment.

### DETAILED DESCRIPTION

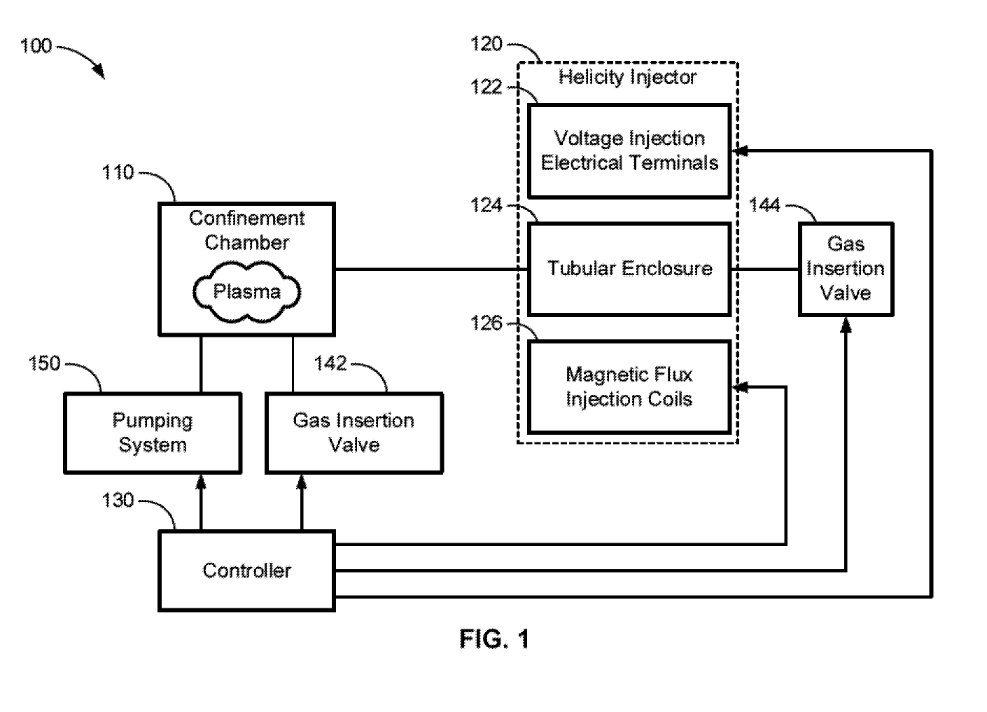

FIG. 1 is a functional block diagram of a plasma confinement system 100. The plasma confinement system 100 includes a confinement chamber 110, a helicity injector 120, and a controller 130.

The confinement chamber 110 holds an ionized gas (plasma). To retain the plasma, the confinement chamber may include seals (gaskets) to create an air tight seal between any boundaries between solid components in the walls of the confinement chamber. For example, any such boundaries may be sealed with one or more gasket seals formed with a fluoroelastomer. The confinement chamber 110 has chamber walls formed of a magnetic flux conserving material. The chamber walls can include a conductive material, such as a copper chromium alloy, to prevent open magnetic field lines from penetrating the chamber walls. In some examples, induced magnetic fields in the chamber walls prevent magnetic flux from penetrating the chamber walls.

The chamber walls thereby provide a helicity barrier to substantially contain magnetic helicity within the confinement chamber 110. As a result, magnetic helicity injected into the confinement chamber 110 is prevented from escaping the confinement chamber 110 and is dissipated in the plasma via collisional resistive processes. The inner wall of the confinement chamber 110 can also be coated with an electrically insulating material to prevent current flow (e.g., discharge) between the walls of the confinement chamber 110 and the plasma. For example, a ceramic material, such as alumina, may be plasma sprayed to coat the inner surfaces of the confinement chamber 110.

The helicity injector 120 includes a tubular enclosure 124, voltage injection electrical terminals 122, and magnetic flux injection coils 126. The tubular enclosure 124 is in fluid connection with the confinement chamber 110. For example, the tubular enclosure can be a curved tube with both ends sealed to corresponding openings in the walls of the confinement chamber 110. In some examples, the tubular enclosure 124 can be 180 degrees of a torus (e.g., a half-torus).

The walls of the tubular enclosure 124 can be formed of a conductive material, such as a copper chromium alloy, to containing magnetic flux, similar to the confinement chamber 110. The inner surfaces of the tubular enclosure 124 can also be coated with an electrically insulating material, such as alumina, to prevent current transfer (e.g., discharge) between the walls of the tubular enclosure 124 and any plasma within the tubular enclosure 124.

In some examples, the walls of the tubular enclosure 124 and the walls of the confinement chamber 110 can be electrically isolated from one another via electrically insulating seals (e.g., fluoroelastomer gaskets) interposed between complementary flanges in the tubular enclosure 124 and the confinement chamber 110. Electrically isolating the walls of the confinement chamber 110 and the tubular enclosure 124 allows for voltages generated between the two to be passed into the plasma, such as to generate currents in the confinement chamber 110, rather than shorted across the respective walls of the confinement chamber 110 and tubular enclosure 124. The seals (e.g., fluoroelastomer gaskets) can be double-layered (e.g., with one seal at an inner position proximate the inner volume of the confinement chamber, and with another seal at an outer position) to further reduce pressure equalization between the confinement chamber 110 and the ambient environment.

The voltage injection electrical terminals 122 are arranged to create a voltage between the two ends of the tubular enclosure 124. The voltage injection electrical terminals 122 can thus create a current that flows through the tubular enclosure 124 from one end to the other. For example, plasma in the inner volume of the tubular enclosure 124 can be directed toward one end of the tubular enclosure 124. The magnetic flux injection coils 126 are arranged to create a magnetic field directed along the length of the tubular enclosure 124. For example, the magnetic flux injection coils 126 can be wrapped around the tubular enclosure 124, in an axial direction so as to create a magnetic field directed longitudinally through the inner volume of the tubular enclosure 124.

Thus, the voltage injection terminals 122 create a current flowing through the tubular enclosure 124 and the magnetic flux injection coils 126 create a magnetic flux through the tubular enclosure, along the direction of the current provided by the voltage injection electrical terminals 122. When operated simultaneously then, an injector current is conveyed along magnetic field lines of a magnetic structure injected into the confinement chamber 110 from one of the ends of the tubular enclosure 124.

In such an arrangement, injected magnetic structure can add helicity to the magnetic configuration of the plasma in the confinement chamber 120. For example, for a torus-shaped confinement chamber, the toroidal and poloidal magnetic fields provide linked field lines, which combine to define the helicity of the magnetic field. The magnetic helicity (i.e., the self-linkage of magnetic flux) is conserved on time scales of collisional resistive energy dissipation in the plasma. On these time scales, the magnetic configuration relaxes toward the state of minimum energy that conserves helicity, which is a magnetic structure with both toroidal and poloidal components that twists over on itself to be largely self-contained. However, to sustain such a helicity-containing magnetic structure over time scales greater than the collisional resistive energy dissipation time scale, it is necessary to inject helicity.

Because the magnetic relaxation time scale is shorter than the time scale of collisional resistive decay, helicity can be added via a magnetic structure with a different topology than the relaxed state, which adds helicity via subsequent relaxation. However, relaxation requires plasma instability to produce asymmetric perturbations for the cross-field current drive and unstable plasma usually have poor confinement. Here a stable plasma is sustained because the perturbations are externally imposed giving a stable confinement configuration without instability and without relaxation.

The density of the plasma in the confinement chamber 110 can be regulated by gas insertion valves 142, 144 in the confinement chamber 110 and tubular enclosure 124, respectively. The gas insertion valves 142, 144 are used to insert gases including a combination of fusion reactants, such as atomic hydrogen, deuterium, tritium, helium, or combinations thereof. Some embodiments may include only one of the gas insertion valves 142, 144. For example, in an embodiment with a gas insertion valve in the tubular enclosure 124, puffs of gas can be inserted into the inner volume of the tubular enclosure 124 and directed to the confinement chamber 110 according to the current through the tubular enclosure 124 created by the voltage injection electrical terminals 122. Injecting gas into the tubular enclosure 124 of the helicity injector 120 may create a slight positive pressure within the internal volume of the tubular enclosure 124, with respect to the confinement chamber 110. Such a positive pressure in the tubular enclosure 124 may prevent plasma from the confinement chamber 110 from entering the tubular enclosure 124 and also provide a current-carrying medium (i.e., the plasma) for the current injected to the confinement chamber 110 via the helicity injector 120. In some embodiments, the rate of gas injection into the tubular enclosure 124 is sufficient to maintain an operational plasma density of the helicity injector 120 (e.g., to prevent starvation of the helicity injector due to insufficient charge carriers to convey the injected current into the confinement chamber 120).

The plasma confinement system 100 can also optionally include a pumping system 150 for pumping the confinement chamber 110 to remove particles from the plasma and thereby regulate the volume. For example, a pumping system 150 may be employed to remove gas at a rate sufficient to maintain an operating density in the confinement chamber. Some embodiments provide for the pumping system 150 to remove a sufficient amount of gas from the plasma to achieve a current density per particle density greater than 10⁻¹⁴ amperes-meters. In some instances, the pumping system 150 may be used to remove particulates produced in fusion reactions, for example. The pumping system 150 may be capable of removing 1000 cubic meters per second from the confinement chamber 110.

In some examples, the pumping system 150 can be omitted where the internal walls (i.e., plasma-facing walls) of the confinement chamber 110 are treated to provide a sink for hydrogen and hydrogen isotopes in the plasma during operation of the plasma confinement system 100. For example, the alumina coated interior wall can be treated with helium plasma to clear loosely bound atoms such as and hydrogen and hydrogen isotopes between operations of the plasma confinement system 100. Upon a subsequent operation of the system 100 the treated alumina walls are able to absorb enough hydrogen and hydrogen isotopes to effectively regulate the density of the plasma to maintain an operational density. For example, a helium-treated inner wall can remove a sufficient amount of gas from the plasma to achieve a current density per particle density greater than 10⁻¹⁴ amperes-meters.

The plasma confinement system 100 can optionally be operated according to a controller 130. As used herein, the controller 130 can refer to one or more control systems implemented in software and/or hardware to operate components in the plasma confinement system 100 to achieve performance described herein. For example, the controller 130 can optionally include a processor executing program instructions stored in a memory to generate control signals. In some instances, the controller 130 can further include a power supply system or can provide control signals to a power supply system for delivering suitable time-varying currents and/or voltages to the magnetic flux injection coils 122 and voltage injection electrical terminals 126 of the helicity injector 120. Additionally or alternatively, one or more features can be achieved through hardware components such as application specific integrated circuits, field programmable gate arrays, etc. Thus, the controller 130 described herein can be implemented through a variety of hardware and/or software modules operating to achieve the described functionality.

The controller 130 can generate control signals to the voltage injection electrical terminals 122, the magnetic flux injection coils 126. In some embodiments, the controller 130 is configured to operate the voltage injection electrical terminals 122 and the magnetic flux injection coils 126 periodically and in phase with respect to one another. For example, the voltage across the ends of the tubular enclosure 124 (set according to voltage on the voltage injection electrical terminals 122) can oscillate according to V_{INJ}(t)=V₀ sin(2πft) where V₀ is the amplitude and f is the frequency. Similarly, the magnetic flux through the tubular enclosure 124 (set according to current in the magnetic flux injection coils 122) can oscillate according to F_{INJ}(t)=F₀ sin(2πft) where F₀ is the amplitude and f is the frequency.

Moreover, the controller 130 can provide control signals to the gas insertion valves 142, 144, and the pumping system 150 to regulate the density of gas in the confinement chamber 110 and/or the tubular enclosure 124 to achieve desired densities.

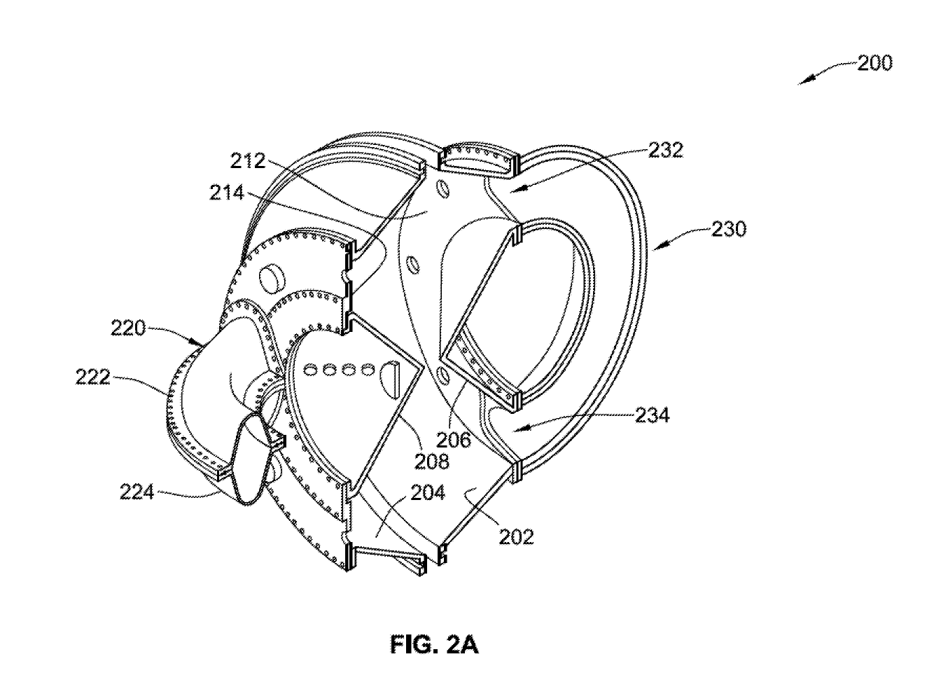

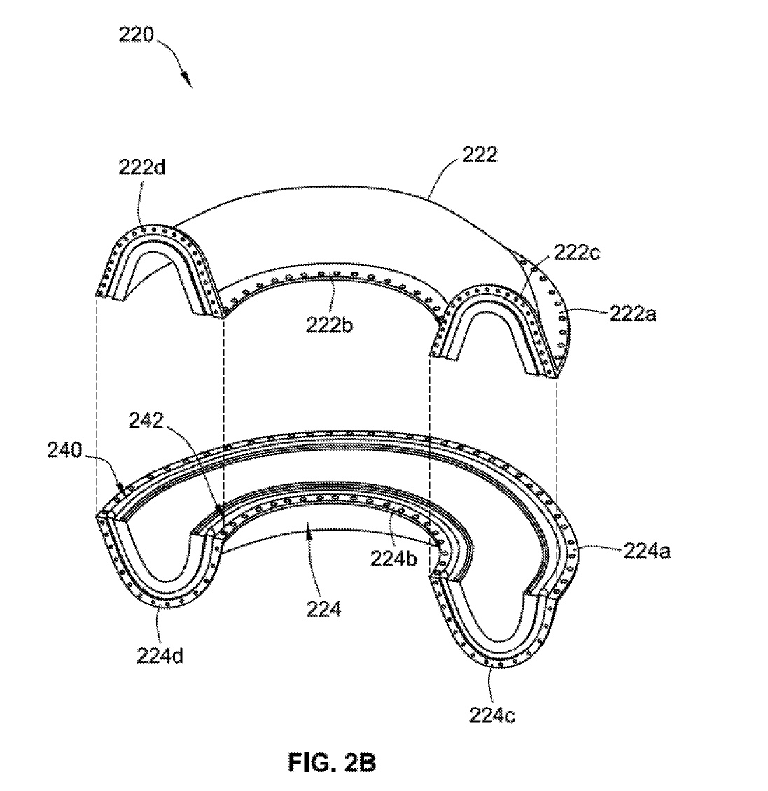

FIG. 2A is a cross-section view of an example plasma confinement system 200 configured to be energized inductively by axially offset helicity injectors 220, 230. The plasma confinement system 200 includes a bow-tie confinement chamber 210, which is an example of a spheromak reactor chamber. The bow-tie confinement chamber 210 is cylindrically symmetric about a central axis of symmetry and has mirror-image symmetry about a plane perpendicular to the central axis of symmetry that bi-sects the confinement chamber 210. The inner walls of the bow-tie confinement chamber 210 can be formed by connecting (e.g., sealing together) four conical sections. For example, as shown in the example configuration of FIG. 2A, the inner walls of the confinement chamber 210 are formed by two outer conical sections 202, 204 defining the outer radial boundary of the confinement chamber 210 and two inner conical surfaces 206, 208 defining the inner radial boundary of the confinement chamber 210.

The inner conical surfaces 206, 208 are oriented with mirror-symmetry about the imaginary bi-secting central plane with their respective apexes pointed toward one another. Further, the apexes of the inner conical surfaces 206, 208 also lie along the axis of symmetry of the cylindrically symmetric confinement chamber 210. The surfaces of the two outer conical sections 202, 204 each extend with cylindrical symmetry from a maximum radius to a minimum radius. The two outer conical sections are oriented with mirror-symmetry about the imaginary bi-secting central plane and with their maximum radius edges facing one another and joined together approximately in the plane of the imaginary bi-secting central plane. The minimum radius edges of the respective outer conical sections 202, 204 are joined to the outer radius edges of the inner conical surfaces 206, 208 by connecting plates 212, 214 each oriented perpendicular to the axis of symmetry of the confinement chamber 210.

The connecting plate 212 is referred to for convenience as the right plate 212 (reflecting its location in the view shown in FIG. 2A on the right hand side of the drawing), and similarly the connecting plate 214 is referred to for convenience as the left plate 214. The two helicity injectors 220, 230 are connected to the confinement chamber via the left and right plates 214, 212, respectively. The first helicity injector 220 is connected to the confinement chamber 210 via a pair of ports in the left plate 214 (although only one port is visible in the cross-section view of FIG. 2A). A second helicity injector 230 is connected to the confinement chamber 210 via a pair of ports 232, 234 in the right plate 212. The first helicity injector 220 includes a curved tubular enclosure with ends arranged to mate with the ports in the left plate 214. Similarly the second helicity injector 230 includes a curved tubular enclosure terminating with ends arranged to mate with the ports 232, 234 in the right plate 212. In some embodiments, the helicity injectors 220, 230 can each be shaped as 180 degrees of a torus (i.e., shaped as a half-torus) with an elongated cross-section.

As shown in the example configuration of FIG. 2A, the two helicity injectors 220, 230 are connected to opposing sides of the confinement chamber 210 (e.g., one is connected to the “right” side, while the other is connected to the “left” side). In addition, the two helicity injectors are axially rotated about the axis of symmetry by 90 degrees with respect to one another. That is, the helicity injectors 220, 230 are arranged such that an imaginary line through the ends of first helicity injector 220 (and the corresponding ports in the left plate 214) is roughly perpendicular to an imaginary line through the ends of the second helicity injector 230 (and the corresponding ports 232, 234 in the right plate 212). In addition, the ends of each of the individual helicity injectors are axially separated by 180 degrees, with respect to the axis of symmetry of the confinement chamber 210. In other words, each of the helicity injectors 220, 230 connects to opposite sides of the respective plates 220, 230, such that the axis of symmetry of the confinement chamber 210 passes through the midpoints of each of the helicity injectors 220, 230.

It is noted, however, that the configuration of the plasma confinement system 200 shown in FIG. 2A with a bow-tie confinement chamber and axially offset half-torus shaped helicity injectors connected to opposing sides is merely one configuration provided for purposes of illustration and example. For example, a plasma confinement system in accordance with the present disclosure may include less than two or more than two helicity injectors, such as 1, 3, 4, etc. Additionally or alternatively, a plasma confinement system in accordance with the present disclosure may include one or more helicity injectors with ends separated by less than 180 degrees with respect to the axis of symmetry of the confinement volume, such as a separation of 60 degrees, 90 degrees, 120 degrees, etc. Additionally or alternatively, a plasma confinement system in accordance with the present disclosure may include a confinement chamber shaped as a torus, such as in a tokomak configuration and/or reverse field pinch configuration, or as an oblate spheroid, such as in a non-bow-tie spheromak configuration, etc. One such alternative configuration may include three helicity injectors connected to a side wall (e.g., a plate) on the same side of a confinement chamber, and with each injector spanning an axial range between ends of less than 120 degrees such that the injectors do not interfere with one another.

FIG. 2B is a disassembled view of the first helicity injector 220 shown in FIG. 2A. The helicity injector includes an upper half 222 and a lower half 224 (so named for purposes of convenience only to reflect the relative positions of the two halves as shown in FIG. 2B). The upper and lower halves 222, 224 can each be formed of a conductive material to contain magnetic flux and/or helicity, such as a copper chromium alloy. Inner surfaces of the two halves 222, 224 can also be coated with an insulating material. For example a thin layer of ceramic material, such as alumina, can be sprayed on the inner surfaces. Furthermore, a double layer of electrically isolating seal gaskets 240, 242 can be interposed between respective flanges of the two halves 222, 224. The double layered seal gaskets 240, 242 can create a pressure seal between the two halves 222, 224 while the corresponding flanges of two halves are tightened together, such as by non-conductive fasteners (e.g., ceramic bolts). The seal gaskets 240, 242 can be formed of an electrically insulating sealing material, such as a fluoroelastomer.

A double layer of seal gaskets 242 seals along the inner radius of the helicity injector 220. The seal gaskets 242 are interposed between the inner flange 222b of the upper half 222 and the inner flange 224b of the lower flange 224. Another double layer of seal gaskets 240 seals along the outer radius of the helicity injector 220. The seal gaskets 240 are interposed between the outer flange 222a of the upper half 222 and the outer flange 224a of the lower half 224. The matching outer flanges 222a, 224a and inner flanges 222b, 224b including corresponding mounting holes for attaching the two halves together. Furthermore, one or more of the flanges may include grooves or channels for receiving the seal gaskets to facilitate the pressure seal.

In addition, the upper half 222 includes end flanges 222c, 222d and the lower half 224 includes end flanges 224c, 224d for mounting to corresponding ports (openings) on the connecting plate 214 of the confinement chamber 210. For example, the end flanges 222c and 224c can mount to a first port in the confinement chamber 210 while the end flanges 222d and 224d can mount to a second port in the confinement chamber 210. A double layer of seal gaskets (not shown) can also be interposed between the respective end flanges 222c-d and 224c-d and the ports on the confinement chamber 210 to electrically isolate the helicity injector 220 from the walls of the confinement chamber 210 and also create a pressure seal.

As will be described in connection with FIG. 3 below, the electric isolation of the two halves 222, 224 of the helicity injector 220 from one another and from the walls of the confinement chamber 210 allow for magnetic flux and voltage to be injected into the helicity injector via external electrical terminals and/or coils. For example, without the electrically isolating break between the first and second halves 222, 224 of the helicity injector 220, a conductive coil wrapped around the helicity injector would allow currents to circulate within the conductive coil and counteract the magnetic field induced within the inner volume of the tubular enclosure of the helicity injector. In addition, electrical isolation between the ends of the helicity injectors and the walls of the confinement chamber 210 prevent the voltage applied across the ends (e.g., the loop voltage) from being shorted into the walls of the confinement chamber. Thus, the electrically isolated components of the helicity injector and the confinement chamber allow for current-carrying plasma to be injected along magnetic field lines, both oriented through the tubular enclosure of the helicity injector.

FIG. 3 is an aspect view of the assembled plasma confinement system 200 shown in FIG. 2 with schematic voltage injection and magnetic flux injection circuits shown for one helicity injector 220. As shown in FIG. 3, a plurality of conductive coils 310 are arranged to generate a magnetic flux inside the helicity injector 220. The generated magnetic flux is directed along the length of the tubular enclosure of the helicity injector 220. The conductive coils 310 can be wound around exterior of the tubular enclosure such that magnetic flux is penetrates to the interior of the helicity injector (due to the gaps between the electrically isolated halves) with a flux direction dependent on the direction of current in the coils 310. The magnetic flux injection coils 310 are connected to a periodic driver 330 to generate periodically oscillating magnetic flux in the interior of the helicity injector.

A plurality of electrical terminals for generating a voltage across the ends of the helicity injector 220 is shown schematically as a transformer coil 320 wound around a closed circular core 322 that is itself wrapped around the exterior of the helicity injector 220. The transformer arrangement schematically represents a driven voltage across the curved loop of the helicity injector 220 for generating a current via plasma within the helicity injector 220. However, it is understood that any combination of windings and/or terminals can be situated around the exterior of the helicity injector 220 and/or confinement chamber 210 so as to generate a voltage across the length of the helicity injector 220 and plasma particles in the inner volume of the helicity injector are thereby urged to convey a current along the magnetic flux generated by the periodic driver 330.

The electrical terminals that generate the voltage across the helicity injector 220 (shown schematically by the transformer coil 320 and core 322) are driven by a periodic driver 332 to generate periodically oscillating voltages (and thus plasma conveyed currents) in the interior of the helicity injector 220. In some embodiments, the periodic drivers 330, 332 for the magnetic flux injector coils 310 and the voltage injection electrical terminals (320), respectively, can be driven in phase such that the injector plasma currents are conveyed along the generated injection fluxes. The periodic driving can be provided by varying the respective current/voltage according to a sine function with substantially the same frequency and with substantially no phase offset between the two periodic drivers 330, 332. The frequency of the drivers can be, for example, a frequency greater than 5.8 kilohertz, such as about 14.5 kilohertz, 14.6 kilohertz, 15 kilohertz, 50 kilohertz, etc.

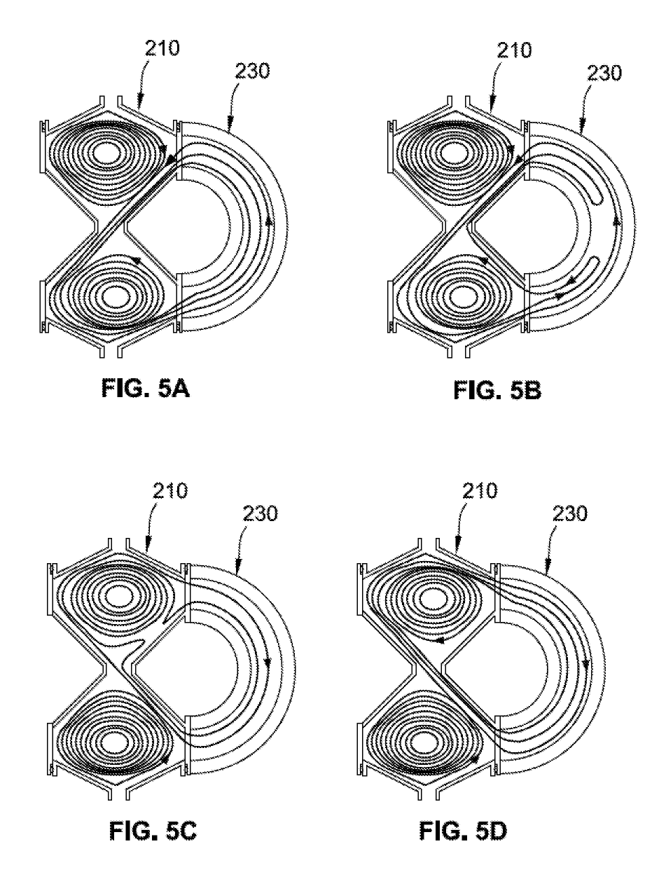

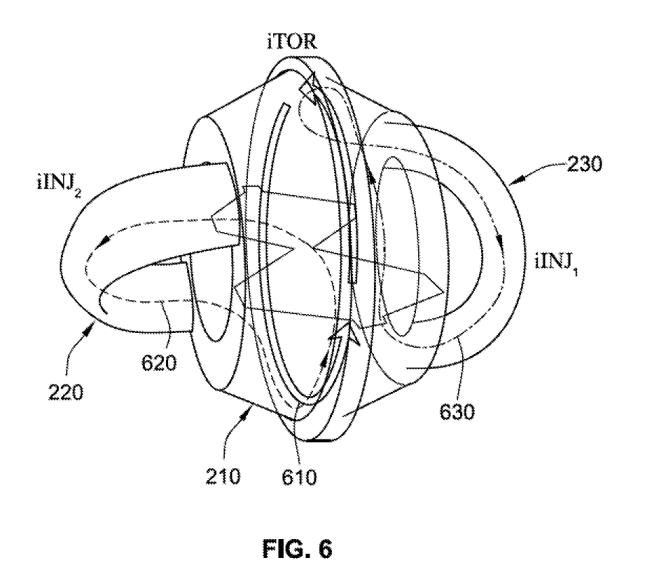

The in-phase injections of magnetic flux and electrical voltage results in an injection of helicity to the plasma in the confinement chamber 210. The effect of the injected helicity is described in connection with the schematics shown in FIG. 5, but generally the magnetic structure formed by the helicity injector 220 exits one end of the helicity injector 220, wraps around the outer surface of plasma in the confinement chamber 210 while circulating in the direction of the toroidal current, and returns into the other end of the helicity injector 220. The injected magnetic structure relaxes in the circulating plasma in the confinement chamber to a lower energy state that conserves helicity. The injected magnetic structure thereby adds helicity to the magnetic structure in the confinement chamber 210 and also energizes the plasma (via excess energy in the plasma following relaxation). Moreover, the current traveling along the field lines of the injected structure drives edge currents around the outer surface of the plasma in the confinement chamber.

Furthermore, the second helicity injector 230 (connected to the opposing side of the confinement chamber 210 in FIG. 3) can also be driven to inject helicity to the confinement chamber by providing in-phase voltage application and magnetic flux injection to generate a magnetic structure that wraps around the outside of the plasma, and passes between the ends of the helicity injector 230, in the direction of the toroidal current of the confined plasma.

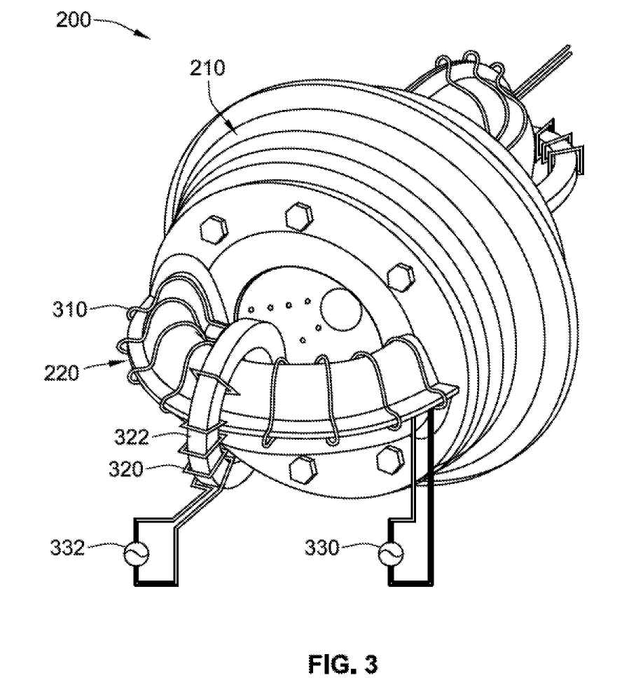

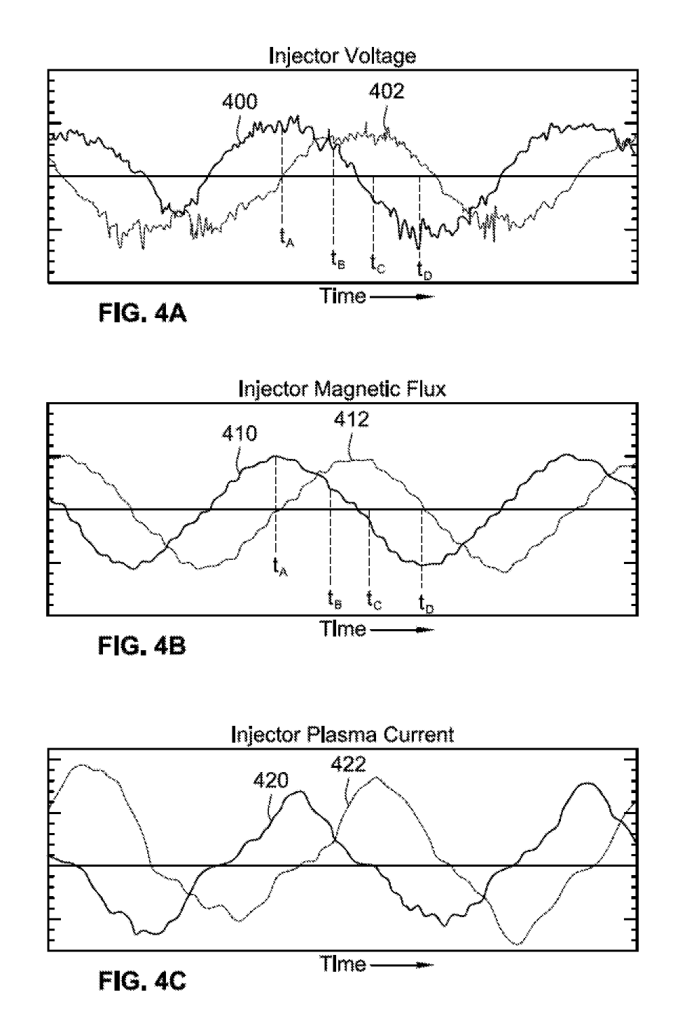

The helicity injected from one of the helicity injectors is approximately proportionate to the product of the voltage across the helicity injector and the flux through the helicity injector. When both are driven in phase, such as both proportionate to sin(2πft), the injected helicity is proportionate to sin²(2πft), which is positive definite. To stability the rate of helicity injection, the second helicity injector can be driven approximately 90 degrees out of phase, such that the injected helicity is proportionate to cos²(2πft). The cumulative injected helicity as a function of time is therefore proportionate to [sin²(2πft)+cos²(2πft)]. FIGS. 4A-4C provide an example of injector voltage, injector magnetic flux, and resulting injector currents for two injectors driven 90 degrees out of phase.

FIG. 4A is an example plot of injector voltage versus time for the helicity injectors 220, 230 in the example plasma confinement system shown in FIG. 3. For example purposes, the trend line 400 shows voltage across the second helicity injector 230, and the trend line 402 shows voltage across the first helicity injector 220. The voltages of each injector are approximately sinusoidal in time, with the voltage of the first helicity injector 220 out of phase by 90 degrees with respect to the second helicity injector.

FIG. 4B is an example plot of injector magnetic flux versus time for the helicity injectors 220, 230 in the example plasma confinement system shown in FIG. 3. For example purposes, the trend line 410 shows magnetic flux through the second helicity injector 230, and the trend line 412 shows magnetic flux through the first helicity injector 220. The magnetic fluxes of each injector 220, 230 are approximately sinusoidal in time, with the magnetic flux of the first helicity injector 220 out of phase by 90 degrees with respect to the second helicity injector. However the voltage and magnetic flux of the second helicity injector 230 are in phase with one another (as shown by the trend lines 400 and 410). For example, the voltages and magnetic fluxes of the second helicity injector 230 are each at or near a maximum at time t_{A} and at or near a minimum at time t_{D}. Similarly, the voltage and magnetic flux of the first helicity injector 220 are in phase with one another (as shown by the trend lines 402 and 412).

FIG. 4C is an example plot of injector plasma current versus time for the helicity injectors 220, 230 in the example plasma confinement system shown in FIG. 3. For example purposes, the trend line 420 shows injector current through the second helicity injector 230, and the trend line 422 shows injector current through the first helicity injector 220. The trend lines 420, 422 for the injector currents reveal that the injector currents each lag behind the corresponding injector voltages (shown with trend lines 410, 412), but still track the general functional form of the injector voltages.

FIGS. 5A-5D are illustrative diagrams of magnetic field lines in the confinement chamber and in one of the helicity injectors at times t_{A}-t_{D} as shown in FIGS. 4A-4C. For clarity, the diagrams in FIGS. 5A-5D illustrate only the poloidal contributions to the magnetic field in the confinement chamber 210. Generally, the magnetic structure in the confinement chamber 210 also has a toroidal component (which would be oriented in and out of the page).

At time t_{A}, illustrated by FIG. 5A, the magnetic flux and applied voltage of the second helicity injector 230 are at their respective maximum positive values. The resulting magnetic structure emerges from the top end of the helicity injector 230, passes through the center of the bow-tie confinement chamber 210, wraps around the plasma in the opposing lobe of the bow-tie confinement chamber 210, and enters back into the bottom end of the helicity injector 230.

At time t_{B}, illustrated by FIG. 5B, the magnetic flux and applied voltage of the second helicity injector 230 are still positive, but decreasing toward zero. The resulting magnetic structure is weaker than the structure shown in FIG. 5A, and emerges from the top end of the helicity injector 230, passes through the center of the bow-tie confinement chamber 210, wraps around the plasma in the opposing lobe of the bow-tie confinement chamber 210, and enters back into the bottom end of the helicity injector 230. Although the magnetic field in the second helicity injector 230 may reverse directions within the helicity injector 230, with field lines following along the inner cone surface.

At time t_{C}, illustrated by FIG. 5C, the magnetic flux and applied voltage of the second helicity injector 230 are negative (i.e., reversed direction from that shown in FIGS. 5A and 5B), but not yet at the minimum values. The resulting magnetic structure emerges from the bottom end of the helicity injector 230, passes through the center of the bow-tie confinement chamber 210, wraps around the plasma in the opposing lobe of the bow-tie confinement chamber 210, and enters back into the top end of the helicity injector 230.

At time t_{D}, illustrated by FIG. 5D, the magnetic flux and applied voltage of the second helicity injector 230 are at their respective minimum negative values. The resulting magnetic structure emerges from the bottom end of the helicity injector 230, passes through the center of the bow-tie confinement chamber 210, wraps around the plasma in the opposing lobe of the bow-tie confinement chamber 210, and enters back into the top end of the helicity injector 230. The times t_{A}-t_{D} thus illustrate stages in a single half-cycle (half period) of the periodically driven helicity injector 230.

FIG. 6 provides indicators of plasma toroidal current iTOR in the confinement chamber and plasma injector currents iINJ₁, iINJ₂ in the helicity injectors of the example plasma confinement system. The circulating arrow 610 indicates the direction of toroidal current iTOR (and magnetic flux) of plasma in the confinement chamber 210. Although generally, the circulating plasma may be defined by a helically wound magnetic structure with both toroidal components (e.g., as shown by the arrow 610) and poloidal components (e.g., as shown by the field lines in the confinement chamber in FIGS. 5A-5D).

The arrow 620 illustrates the direction of injector current iINJ₁ from the plasma conveyed along the magnetic structure injected by the first helicity injector 220. As shown in FIG. 6, between the ends of the first helicity injector 220, the injector current iINJ₁ includes a component along the direction of the confined plasma's toroidal current iTOR. Although the injector current iINJ₁ also drives poloidal edge currents around the outer boundary of the confined plasma. Similarly, the arrow 630 illustrates the direction of injector current from the plasma conveyed along the magnetic structure injected by the second helicity injector 230. As shown in FIG. 6, between the ends of the second helicity injector 230, the injector current iINJ₂ includes a component along the direction of the confined plasma's toroidal current iTOR. Although the injector current iINJ₂ also drives poloidal edge currents around the outer boundary of the confined plasma.

The quadrature injector current is defined as the quadrature sum of the two injector currents, iINJ=(iINJ₁²+iINJ₂²)^{1/2} averaged over an injector cycle. Current gain of the plasma confinement system can thus be defined according to iTOR/iINJ.

In some embodiments, the plasma may be substantially magnetically contained in a separatrix, a helically wound closed magnetic structure. The separatrix is characterized by self-linkage of magnetic field lines, (e.g., no magnetic field lines penetrating the boundary defining the separatrix). Without constant helicity injection, the separatrix can degrade by collisional resistive processes, but while helicity is injected via the magnetic structures provided by the helicity injectors that relax to add helicity to the circulating plasma, a separatrix may be maintained.

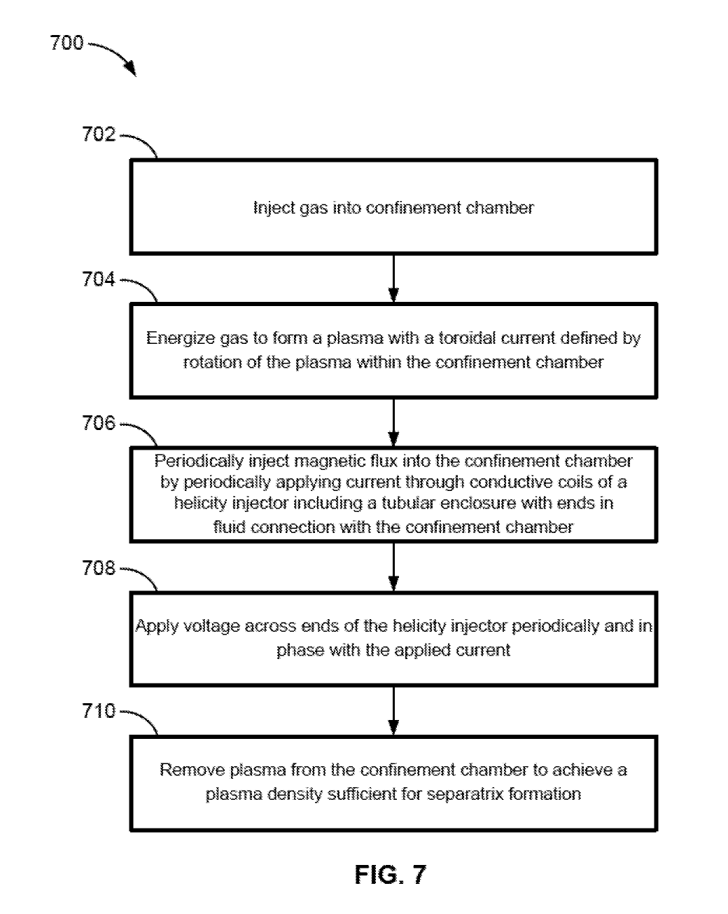

FIG. 7 is a flowchart of a process 700 for operating a plasma confinement system according to an example embodiment. Gas is injected into a confinement chamber (702). For example, with reference to the plasma confinement system 100 shown in FIG. 1, gas may be injected via one or more of the gas injection valves 142, 144. The injected gas is energized to form a plasma with a toroidal current defined by rotation of the plasma within the confinement chamber (704). For example, the gas may be energized inductively by operation of one or more helicity injectors injecting magnetic structures driving edge currents about the outer surface of the plasma and relaxing to add helicity to the magnetic structure of the plasma similar to the discussion above. Although, other techniques may be employed to energize plasma in the confinement chamber, such by discharging a large voltage across the confinement chamber from a capacitor bank, etc.

Once the plasma is formed in the confinement chamber, helicity is periodically injected into the confinement chamber to provide. Current is applied through conductive coils of a helicity injector including a tubular enclosure in fluid connection with the confinement chamber via first and second ports (706). The conductive coils can be wrapped around the helicity injector so as to generate a magnetic flux through the tubular enclosure, which magnetic flux is then inserted into the confinement chamber. A voltage is applied across the first and second ports of the helicity injector periodically and in phase with the applied current (708). The applied voltage causes plasma in the helicity injector to flow to create a current along the magnetic field lines, which forms the injector current of the magnetic structure in the confinement chamber created by the helicity injector. The generated magnetic structure drives edge currents around the exterior surface of the plasma in the confinement chamber. The generated magnetic structures also create asymmetric magnetic perturbations across the plasma sufficient to couple adjacent zonal flows circulating within the confinement chamber, such as zonal flows in the electron fluid circulating according the toroidal current in the confinement chamber.

To create plasma conditions suitable for separatrix formation, the plasma density is regulated by removing gas from the confinement chamber (710). The removal of gas from the confinement chamber can be carried out to maintain a plasma density for separatrix formation even as additional gas is added via the helicity injectors to provide charge carriers for the injector currents. In some examples, the removal of gas is sufficient to achieve a current density per particle density that exceeds 10⁻¹⁴ amperes-meters.

In some embodiments of the present disclosure, plasma within a confinement chamber is driven by a dynamo current drive mechanism to substantially self-generate a plasma-confining magnetic field. The dynamo mechanism is driven by injected helicity, which creates asymmetric fluctuations in the magnetic field of a confinement chamber. The asymmetric fluctuations (perturbations) couple to electron fluid in the plasma to drive current. As described below, the dynamo current drive mechanism can operate to generate a current-carrying separatrix (i.e., a self-contained magnetic structure) within a confinement chamber when helicity injectors impose a sufficient amount of asymmetric magnetic fluctuations. Accordingly, the dynamo current drive mechanism provides a set of criteria for operating a plasma confinement chamber to generate a current-carrying separatrix by inductively energizing plasma in the chamber with one or more helicity injectors.

The magnetic field is frozen in the electron fluid of the plasma. Thus, imposed perturbations move with the electron fluid and are distorted by the equilibrium electron velocity shear to drive current on the inner flux surfaces. Because the electron fluid is frozen in the magnetic field, it is the electron flow that produces the currents that cause distortions for coupling adjacent zonal flows in the circulating plasma. Thus,

δvₑ≈−δⱼ/(ne), (1)

where n is the electron density, e is the electron charge, and δvₑ is a distortion in electron velocity, and δⱼ is a variation in plasma current.

The two-fluid parallel generalized Ohm's law for turbulent plasma is given by:

E_{∥}=−<δvₑ×δB>_{∥}+ηj_{∥} (2)

### Therefore,

−<δj×δB>_{∥}/(ne)=ηj_{∥}−E_{∥} (3)

where η is the resistivity, j is the current density, n is the electron density, and e is the electron charge. The angle brackets “< >” in equations (2) and (3) indicate a time averages over the pertinent period of oscillation.

The parallel current driving force per unit volume (ηjne−Ene)_{∥} is supplied to circulate a confined current. To estimate the level of fluctuations required to drive the current inside a mean flux surface a cylinder with a uniform axial magnetic field and current density j_{z} is considered. Integrating over the volume inside the cylinder and reducing the left side of Eq. (3) to the Maxwell stress-induced force due to fluctuations on the surface yields:

−∫[δB_{⊥}δB_{z}/μ₀]da=∫ne(ηj_{z}−E_{z})dvol (4)

where δB_{⊥} and δB_{z} are the fluctuations at the surface perpendicular to the surface and parallel to the axis respectively and j_{z} and E_{z} are parallel to B. Time averaged E_{z} is zero in steady state, but is negative during ramp up of the current. The maximum strength of the current drive is limited by the amplitude of imposed perturbations that can become distorted.

According to the assumption of gross distortion the left side of Equation (4) reaches a maximum when slippage occurs and the net contribution of δB_{z} is primarily produced by the bending of the imposed δB_{⊥} causing the kernel to be proportional to δB_{⊥}². Equation (4) can be used to approximate a mean flux surface by substituting tor for z and assuming positive jₜₒᵣ and saturation at (δB_{⊥}²)/(2μ₀).

(δB_{⊥rms})²/(2μ₀)2πR₀2πr≧(ηjₜₒᵣ−Eₜₒᵣ)neπr²2πR₀ (5)

where (δB_{⊥rms})² is the imposed fluctuating field perpendicular to the mean flux surface and r and R₀ are the minor and major radii of the toroidal confinement chamber, respectively. The left side of Equation (5) is the maximum force that can be transmitted to the inside of the flux surface and the right side of Equation (5) is the force required to drive the current inside the flux surface where (ηjₜₒᵣne) is the force per volume to drive current against resistance and −neEₜₒᵣ is the force per volume to raise B according to Faraday's law.

In the inequality of Equation (5), the equal sign is true when slippage occurs. The inequality applies when the imposed fluctuations are higher than necessary to drive the enclosed current and no slippage occurs. Thus, operating the helicity injectors of a plasma confinement system to induce magnetic field fluctuations (δB_{⊥rms})² that satisfy the inequality of Equation (5) is sufficient to form a separatrix in the confined plasma. Evaluating Ampere's law along an injector current path (e.g., one of the current paths iINJ1, iINJ2 shown in FIG. 6) yields a relationship between δB_{⊥rms} and iINJ, which is the quadrature sum of the injector currents averaged over an injector cycle:

δB_{⊥rms}=(μ₀iINJ)/(4πr) (6)

where r is the inner radius of the confinement chamber.

Furthermore, for uniform j_{∥}, the inductance per length is μ₀/4π and the resistance per length is η/πa². Assuming slippage at r=a, these approximations yield:

Iₜₒᵣ/πa²=jₜₒᵣ (7)

τ_{L/R}=μ₀a²/4η (8)

Eₜₒᵣ=μ₀İₜₒᵣ/4π (9)

where τ_{L/R} is the helicity decay time and is obtained from helicity balance.

Equations (6)-(9) can be substituted into Equation (5) for r=a, at the equality (due to assumption of slippage), to yield:

Iᵢₙⱼ²=4πa³ne(Iₜₒᵣ/τ_{L/R}+İₜₒᵣ)2 (10)

The non-symmetric edge magnetic fields agree with that of the injector component of the Taylor state which is proportional to the injector current. Therefore, Iinj is proportional to the imposed fluctuation amplitude and its square is the correct quantity to use as the source term. The factor of 2 on the right side of equation (10) is for energy build up in the toroidal field which, in a force free equilibrium, is equal to that in the poloidal field. Solving for İₜₒᵣ yields:

İₜₒᵣ+Iₜₒᵣ/τ_{L/R}=C₁Iᵢₙⱼ²/(8πa³ne) (11)

where C₁ is a numeric factor on the order of one to account for the approximations described above.

Thus, a plasma confinement system with helicity injectors can be driven to form a separatrix via dynamo current drive by driving the helicity injectors with a time-averaged quadrature summed injection current Iᵢₙⱼ given by equation (10).

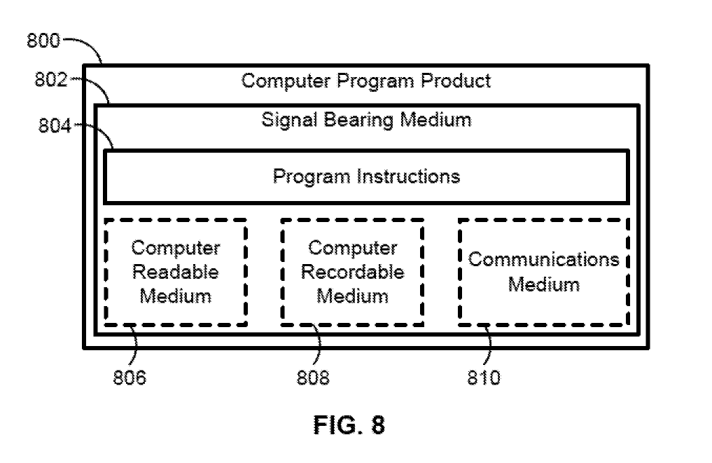

FIG. 8 depicts a computer-readable medium configured according to an example embodiment. In example embodiments, the example system can include one or more processors, one or more forms of memory, one or more input devices/interfaces, one or more output devices/interfaces, and machine-readable instructions that when executed by the one or more processors cause the system to carry out the various functions, tasks, capabilities, etc., described above.

As noted above, in some embodiments, the disclosed techniques can be implemented by computer program instructions encoded on a non-transitory computer-readable storage media in a machine-readable format, or on other non-transitory media or articles of manufacture (e.g., executable instructions stored on a memory of the controller 130). FIG. 8 is a schematic illustrating a conceptual partial view of an example computer program product that includes a computer program for executing a computer process on a computing device, arranged according to at least some embodiments presented herein.

In one embodiment, the example computer program product 800 is provided using a signal bearing medium 802. The signal bearing medium 802 can include one or more programming instructions 804 that, when executed by one or more processors can provide functionality or portions of the functionality described above with respect to FIGS. 1-7. In some examples, the signal bearing medium 802 can be a computer-readable medium 806, such as, but not limited to, a hard disk drive, a Compact Disc (CD), a Digital Video Disk (DVD), a digital tape, memory, etc. In some implementations, the signal bearing medium 802 can be a computer recordable medium 808, such as, but not limited to, memory, read/write (R/W) CDs, R/W DVDs, etc. In some implementations, the signal bearing medium 802 can be a communications medium 810, such as, but not limited to, a digital and/or an analog communication medium (e.g., a fiber optic cable, a waveguide, a wired communications link, a wireless communication link, etc.). Thus, for example, the signal bearing medium 802 can be conveyed by a wireless form of the communications medium 810.

The one or more programming instructions 804 can be, for example, computer executable and/or logic implemented instructions. In some examples, a computing device such as the controller 130 of FIG. 1 is configured to provide various operations, functions, or actions in response to the programming instructions 804 and/or executable instructions conveyed to a processor or processors by one or more of the computer readable medium 806, the computer recordable medium 808, and/or the communications medium 810.

The non-transitory computer readable medium could also be distributed among multiple data storage elements, which can be remotely located from each other. The computing device that executes some or all of the stored instructions can be a handheld device, such as a personal phone, tablet, etc. Alternatively, the computing device that executes some or all of the stored instructions can be another computing device, such as a server.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

We claim:

1. A method of inductively energizing a plasma in a confinement chamber, comprising:
(a) inserting into the confinement chamber a gas comprising atomic hydrogen, deuterium, tritium, helium, or combinations thereof;
(b) energizing the gas to form a plasma having a toroidal current defined by rotation of the plasma within the confinement chamber;
(c) injecting magnetic flux into the confinement chamber by applying current through conductive coils of at least one helicity injector, wherein the at least one helicity injector comprises a tubular enclosure with two ends both fluidly connected with the confinement chamber;
(d) applying a voltage across the two ends of the at least one helicity injector to create: (i) edge currents around an outer surface of the plasma in the confinement chamber, and (ii) asymmetric magnetic perturbations across the plasma sufficient to couple adjacent zonal flows circulating within the confinement chamber along the direction of the toroidal current; and
(e) removing plasma from the confinement chamber to achieve a plasma density sufficient for separatrix formation,
wherein the injecting magnetic flux and the applying voltage via the at least one helicity injector are carried out periodically and in phase with respect to one another at a frequency that exceeds 5.8 kilohertz.

2. The method according to claim 1, wherein the at least one helicity injector includes a first helicity injector and a second helicity injector, wherein each of the first and second helicity injectors comprise a tubular enclosure with two ends both fluidly connected to the confinement chamber,
wherein the injecting magnetic flux and the applying voltage via the first helicity injector are carried out periodically and in phase with respect to one another at a frequency that exceeds 5.8 kilohertz, and
wherein the injecting magnetic flux and the applying voltage via the second helicity injector are carried out periodically and in phase with respect to one another at a frequency that exceeds 5.8 kilohertz.

3. The method according to claim 2, wherein the first helicity injector is connected to a first side of the confinement chamber and the second helicity injector is connected to a side of the confinement chamber opposite the first side, and wherein the first and second helicity injectors are oriented such that a line connecting the two ends of the first helicity injector is oriented substantially perpendicularly to a line connecting the two ends of the second helicity injector.

4. The method according to claim 2, wherein the in phase injecting magnetic flux and applying voltage via the first helicity injector and the in phase injecting magnetic flux and applying voltage via the second helicity injector are offset in phase by approximately 90 degrees.

5. The method according to claim 2, further comprising:
inserting additional gas comprising at least one of atomic hydrogen, deuterium, tritium, helium, or combinations thereof through a valve within at least one of the first or second helicity injectors so as to create a greater pressure within the at least one of the first or second helicity injectors than in the confinement chamber so as to maintain operational plasma density in the at least one of the first or second helicity injectors.

6. The method according to claim 1, wherein the removing gas includes pumping the chamber with an external pumping system.

7. The method according to claim 1, wherein a confining wall of the confinement chamber and a confining wall of the tubular enclosure of the at least one helicity injector are each formed of a flux conserver material comprising a copper alloy.

8. The method according to claim 7, wherein the tubular enclosure of the at least one helicity injector includes electrically insulating seal gaskets dividing the flux conserver material into two electrically isolated portions.

9. The method according to claim 7, wherein the tubular enclosure of the at least one helicity injector is electrically isolated from the confinement chamber via electrically insulating seal gaskets.

10. The method according to claim 1, wherein the injecting magnetic flux and the applying voltage are carried out periodically and in phase with respect to one another at a frequency of at least 14.5 kilohertz.

11. The method according to claim 1, wherein the removing gas is sufficient to achieve a toroidal current density per particle density in the plasma that exceeds 10⁻¹⁴ amperes-meters.

12. The method according to claim 1, wherein the removing gas is carried out by binding hydrogen and hydrogen isotopes to an inner plasma-facing wall of the confinement chamber comprising alumina treated with helium plasma.

13. The method according to claim 1, wherein the confinement chamber is torus-shaped.

14. A plasma confinement system comprising:
(a) a confinement chamber for confining a gas comprising atomic hydrogen, deuterium, tritium, helium, or combinations thereof that is energized to form a plasma;
(b) at least one helicity injector including:
a tubular enclosure with two ends both fluidly connected with the confinement chamber via first and second ports;
conductive coils arranged such that current in the conductive coils results in magnetic flux injected into the confinement chamber;
electrical terminals arranged to apply a voltage across the ends of the at least one helicity injector to thereby create: (i) edge currents around an outer surface of the plasma in the confinement chamber, and (ii) asymmetric magnetic perturbations across the plasma sufficient to couple adjacent zonal flows circulating within the confinement chamber; and
(c) a controller configured to operate the conductive coils and electrical terminals of the at least one helicity injector so as to inductively energize plasma in the confinement chamber.

15. The plasma confinement system according to claim 14, wherein the at least one helicity injector includes a first helicity injector and a second helicity injector, wherein each of the first and second helicity injectors comprise a tubular enclosure with two ends both fluidly connected to the confinement chamber,
wherein the controller is further configured to operate conducive coils and electrical terminals of the second helicity injector so as to inductively energize plasma in the confinement chamber by:
injecting magnetic flux and applying voltage via the first helicity injector periodically and in phase with respect to one another at a frequency that exceeds 5.8 kilohertz, and
injecting magnetic flux and applying voltage via the second helicity injector periodically and in phase with respect to one another at a frequency that exceeds 5.8 kilohertz.

16. The plasma confinement system according to claim 15, wherein the first helicity injector is connected to a first side of the confinement chamber and the second helicity injector is connected to a side of the confinement chamber opposite the first side, and wherein the first and second helicity injectors are oriented such that a line connecting the two ends of the first helicity injector is oriented substantially perpendicularly to a line connecting the two ends of the second helicity injector.

17. The plasma confinement system according to claim 15, further comprising:
a gas insertion valve in at least one of the first or second helicity injectors, and wherein the controller is further configured to operate the gas insertion valve to inject additional gas into the at least one of the first or second helicity injectors so as to maintain operational plasma density in the at least one of the first or second helicity injectors.

18. The plasma confinement system according to claim 14, wherein a confining wall of the confinement chamber and a confining wall of the tubular enclosure of the at least one helicity injector are each formed of a flux conserver material comprising a copper alloy, and wherein the tubular enclosure of the at least one helicity injector includes electrically insulating seal gaskets dividing the flux conserver material into two electrically isolated portions.

19. The plasma confinement system according to claim 14, further comprising:
a pumping system for regulating plasma density in the confinement chamber sufficient to achieve a toroidal current density per particle density in the plasma that exceeds 10⁻¹⁴ amperes-meters.

20. The plasma confinement system according to claim 14, wherein the confinement chamber is torus-shaped.

21. (canceled)

22. A computer readable medium storing instructions that, when executed by one or more processors in a computing device, cause the computing device to perform operations, the operations comprising:
(a) inserting into a confinement chamber a gas comprising atomic hydrogen, deuterium, tritium, helium, or combinations thereof;
(b) energizing the gas to form a plasma having a toroidal current defined by rotation of the plasma within the confinement chamber;
(c) injecting magnetic flux into the confinement chamber by applying current through conductive coils of at least one helicity injector, wherein the at least one helicity injector comprises a tubular enclosure with two ends both fluidly connected with the confinement chamber;
(d) applying a voltage across the two ends of the at least one helicity injector to create: (i) edge currents around an outer surface of the plasma in the confinement chamber, and (ii) asymmetric magnetic perturbations across the plasma sufficient to couple adjacent zonal flows circulating within the confinement chamber along a direction of the toroidal current; and
(e) removing gas from the confinement chamber to achieve a plasma density sufficient for separatrix formation,
wherein the injecting magnetic flux and the applying voltage via the at least one helicity injector are carried out periodically and in phase with respect to one another at a frequency that exceeds 5.8 kilohertz.

23-24. (canceled)
